(19) United States
(12) Patent Application Publication
(10) Pub. No.: US 2006/0045974 A1
(43) Pub. Date: Mar. 2, 2006

(54) Wet chemical method to form silver-rich silver-selenide

(76) Inventors: Kristy A. Campbell, Boise, ID (US); Rita J. Klein, Boise, ID (US)

Correspondence Address: DICKSTEIN SHAPIRO MORIN & OSHINSKY LLP, 2101 L STREET, NW, WASHINGTON, DC, 20037, US

(21) Appl. No.: 10/925,244

(22) Filed: Aug. 25, 2004

(51) Int. Cl. B05D 5/12

(52) U.S. Cl. 427/304; 427/76

(57) ABSTRACT

A method of forming a silver-rich silver-selenide layer is provided. The method includes plating a silver layer on a silver-selenide layer using an electroless process and diffusing silver into the silver-selenide layer. Also, a method of forming a memory element is provided. The memory element is formed by forming a first electrode and forming a first layer of resistance variable material over the first electrode. A silver-selenide layer is formed over the first layer of resistance variable material and a silver layer is plated on the silver-selenide layer by an electroless process.

### FIELD OF THE INVENTION

The invention relates to the field of random access memory (RAM) devices formed using a resistance variable material, and in particular to an improved method of manufacturing a resistance variable memory element.

### BACKGROUND OF THE INVENTION

A well known semiconductor memory component is a random access memory (RAM). RAM permits repeated read and write operations on memory elements. Typically, RAM devices are volatile, in that stored data is lost once the power source is disconnected or removed. Non-limiting examples of RAM devices include dynamic random access memory (DRAM), synchronous dynamic random access memory (SDRAM), and static random access memory (SRAM). DRAMS and SDRAMS typically store data in capacitors that require periodic refreshing to maintain the stored data. Although volatile, SRAMS do not require refreshing.

Recently, resistance variable memory elements, which include programmable conductor random access memory (PCRAM) elements, have been investigated for suitability as semi-volatile and non-volatile random access memory elements. Generally, a programmable conductor memory element includes an insulating dielectric material formed of a chalcogenide glass disposed between two electrodes. A conductive material, such as silver, is incorporated into the dielectric material. The resistance of the dielectric material can be changed between high resistance and low resistance states depending upon movement of the conductive material within or into and out of the dielectric material in accordance with applied voltage.

One preferred resistance variable material comprises a chalcogenide glass. A specific example is germanium-selenide (GeₓSe₁₀₀₋ₓ) containing a silver (Ag) component. One method of providing silver to the germanium-selenide composition is to initially form a germanium-selenide glass and then deposit a thin silver layer upon the glass, for example by sputtering, physical vapor deposition, or other known techniques in the art. The silver layer is irradiated, preferably with electromagnetic energy at a wavelength less than 600 nanometers, so that the energy passes through the silver and to the silver/glass interface, to break a chalcogenide bond of the chalcogenide material such that the glass is doped or photodoped with silver. Another method for providing silver to the glass is to provide a silver-selenide layer on a germanium-selenide glass. A top electrode comprising silver is then formed over the silver-germanium-selenide glass or, in the case where a silver-selenide layer is provided over a germanium-selenide glass, the top electrode is formed over the silver-selenide layer.

It has been found that over time devices fabricated by the above described methods may fail if excess silver from a top silver containing electrode continues to diffuse into the silver germanium-selenide glass or into the silver-selenide layer and eventually into the germanium-selenide glass layer (the primary switching area) below the silver-selenide layer. Furthermore, during semiconductor processing and/or packaging of a fabricated structure that incorporates the memory element, the element undergoes thermal cycling or heat processing. Heat processing can result in undesirable amounts of silver migrating into the memory element. Too much silver incorporated into the memory element may result in faster degradation, i.e., a short life, and eventually device failure.

Typically, a chalcogenide-based programmable conductor memory element is formed by depositing a silver layer onto a silver-selenide layer to achieve a silver-rich silver-selenide layer. For optimum cell operation, it is desirable to control the amount of excess silver incorporated into the silver-selenide layer. However, it is difficult to control the amount of silver diffused into the silver-selenide layer when the silver layer is deposited using sputter deposition or evaporation techniques since these methods result in an unknown amount of silver being incorporated into the silver-selenide layer.

Thus, there is a desire and need for a method of forming silver-rich silver-selenide films for controlling the excess silver that is diffused into the silver-selenide layer.

### BRIEF SUMMARY OF THE INVENTION

Exemplary embodiments of the invention include a method of forming a silver-rich silver-selenide layer by plating a silver layer on a silver-selenide layer using an electroless process and diffusing silver into the silver-selenide layer. Exemplary embodiments of the invention also include a method of forming a memory element. The memory element is formed by forming a first electrode and forming a first layer of resistance variable material over the first electrode. A silver-selenide layer is formed over the first layer of resistance variable material and a silver layer is plated on the silver-selenide layer by an electroless process.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 illustrates a cross-sectional view of a memory element fabricated in accordance with a first embodiment of the invention and at an initial stage of processing;

FIGS. 2-7 illustrate a cross-sectional view of the memory element of FIG. 1 at intermediate stages of processing;

FIG. 8 illustrates a cross-sectional view of a memory element according to another exemplary embodiment of the invention; and

FIG. 9 illustrates a processor-based system having a memory element formed according to the invention.

### DETAILED DESCRIPTION OF THE INVENTION

In the following detailed description, reference is made to various specific embodiments of the invention. These embodiments are described with sufficient detail to enable those skilled in the art to practice the invention. It is to be understood that other embodiments may be employed, and that various structural, logical and electrical changes may be made without departing from the spirit or scope of the invention.

The term “substrate” used in the following description may include any supporting structure including, but not limited to, a semiconductor substrate that has an exposed substrate surface. A semiconductor substrate should be understood to include silicon-on-insulator (SOI), silicon-on-sapphire (SOS), doped and undoped semiconductors, epitaxial layers of silicon supported by a base semiconductor foundation, and other semiconductor structures. When reference is made to a semiconductor substrate or wafer in the following description, previous process steps may have been utilized to form regions or junctions in or over the base semiconductor or foundation. The substrate need not be semiconductor-based, but can be any support structure suitable for supporting an integrated circuit. For example, the substrate can be ceramic or polymer-based.

The term “silver” is intended to include not only elemental silver, but silver with other trace metals or in various alloyed combinations with other metals as known in the semiconductor industry, as long as such silver alloy is conductive, and as long as the physical and electrical properties of the silver remain unchanged.

The term “silver-selenide” is intended to include various species of silver-selenide, including some species which have a slight excess or deficit of silver, for instance, Ag2Se, Ag2+xSe, and Ag2−xSe.

The term “resistance variable memory element” is intended to include any memory element, including Programmable Conductive Random Access Memory (PCRAM) elements, which exhibit a resistance change in response to an applied voltage.

The term “chalcogenide glass” is intended to include glasses that comprise an element from group VIA (or group 16) of the periodic table. Group VIA elements, also referred to as chalcogens, include sulfur (S), selenium (Se), tellurium (Te), polonium (Po), and oxygen (O).

Embodiments of the invention provide a method of forming a chalcogenide material containing device, such as, and without limitation, a resistance variable memory element, that does not suffer from the drawbacks associated with conventional fabrication methods. In accordance with the present invention, a silver layer is deposited onto a silver selenide substrate using an electroless plating bath.

Electroless plating of metal films onto different substrates is a very important process in areas such as surface coating and electronics fabrication. In general, electroless plating is the deposition of a metal coating by immersion of a substrate in a suitable bath containing a metal salt and a chemical reducing agent. The metal ions are reduced by the reducing agent in the plating solution and deposited on the substrate to a desired thickness.

The electroless plating process, once initiated, is an autocatalytic oxidation/reduction reaction, requiring only occasional replenishment of the aqueous bath. The process resembles electroplating in that the plating process may be run continuously to build up a thick metal coating on the substrate. Electroless plating differs from electroplating in that the electrons used for reduction are supplied by a chemical reducing agent present in solution. Thus, no outside current is needed for electroless plating.

One attractive benefit of electroless plating over electroplating is the ability to plate a substantially uniform metallic coating onto a substrate having an irregular shape. Frequently, electroplating an irregularly shaped substrate produces a coating having non-uniform deposit thicknesses because of varying distances between the cathode and anode of the electrolytic cell. Electroless plating techniques do not exhibit this problem, as they do not make use of electrolytic cells. Another advantage of electroless plating is that electroless coatings are virtually nonporous, which allows for greater corrosion resistance than electroplated substrates.

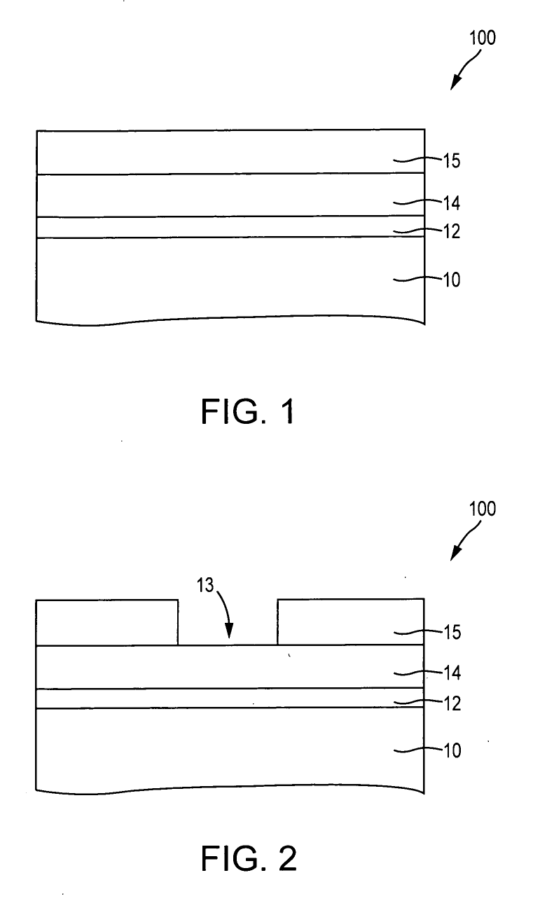

The invention will now be explained with reference to the figures, which illustrate exemplary embodiments and where like reference numbers indicate like features. FIG. 1 depicts an initial processing stage for the formation of a memory element according to an exemplary embodiment of the invention. A portion of an optional insulating layer 12 is formed over a semiconductor substrate 10, for example, a silicon substrate having circuitry fabricated thereon. It should be understood that the memory elements of the invention can be formed over a variety of substrate materials and not just semiconductor substrates such as silicon, as shown above. For example, the optional insulating layer 12 may be formed on a ceramic or polymer-based substrate. The insulating layer 12 may be formed by any known deposition methods, such as sputtering by chemical vapor deposition (CVD), plasma enhanced CVD (PECVD) or physical vapor deposition (PVD). The insulating layer 12 may be formed of a conventional insulating oxide, such as silicon oxide (SiO₂), a silicon nitride (Si₃N₄), or a low dielectric constant material, among many others.

A first electrode layer 14 is formed over the insulating layer 12, as also illustrated in FIG. 1. The first electrode layer 14 may comprise any conductive material, for example, tungsten, nickel, tantalum, aluminum, or platinum, among many others. A first dielectric layer 15 is formed over the first electrode 14. The first dielectric layer 15 may comprise the same or different materials as those described above with reference to the insulating layer 12.

Referring now to FIG. 2, an opening 13 extending to the first electrode layer 14 is formed in the first dielectric layer 15. The opening 13 may be formed by any method, such as, by conventional photolithographic processes.

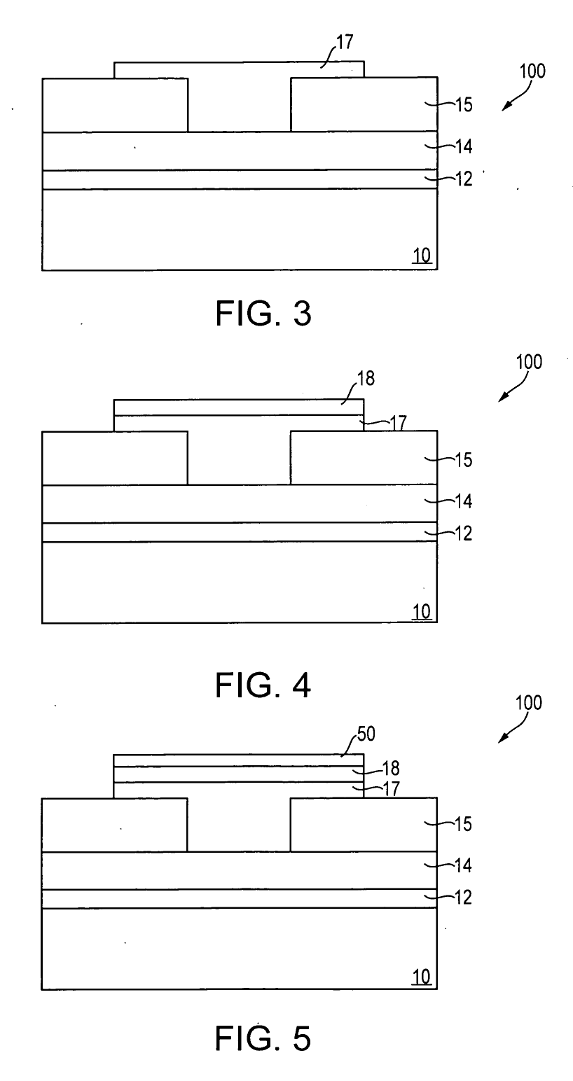

A chalcogenide glass layer 17 is formed over the second insulating layer 15, to fill in the opening 13, as shown in FIG. 3. According to an embodiment of the invention, the chalcogenide glass layer 17 can be germanium-selenide glass having a GeₓSe₁₀₀₋ₓ stoichiometry. The preferred stoichiometric range is between about Ge₂₀Se₈₀ to about Ge₄₃Se₅₇ and is more preferably about Ge₄₀Se₆₀. The chalcogenide glass layer 17 preferably has a thickness from about 100 Angstroms (Å) to about 1000 Å and is more preferably about 150 Å.

The formation of the chalcogenide glass layer 17, having a stoichiometric composition in accordance with the invention, may be accomplished by any suitable method. For instance, germanium-selenide glass can be formed by evaporation, co-sputtering germanium and selenium in the appropriate ratios, sputtering using a germanium-selenide target having the desired stoichiometry, or chemical vapor deposition with stoichiometric amounts of germanium tetrahydride (GeH₄) and selenium hydride (SeH₂) gases (or various compositions of these gases), which result in a germanium-selenide film of the desired stoichiometry, are examples of methods which may be used.

As shown in FIG. 4, a silver-selenide layer 18 is deposited on the surface of the chalcogenide glass layer 17. A variety of processes can be used to form the silver-selenide layer 18. For instance, physical vapor deposition techniques such as evaporative deposition and sputtering may be used. Other processes such as chemical vapor deposition, co-evaporation or depositing a layer of selenium above a silver layer to form the silver-selenide layer 18 can also be used.

The use of a metal containing layer, such as a silver-selenide layer 18, in contact with the chalcogenide glass layer 17 makes it unnecessary to photodope the glass with silver. As an optional variant, however, it is possible to also metal dope using, for example, silver, the chalcogenide glass layer 17, which is in contact with the silver-selenide layer 18.

Preferably, the thickness of layers 17, 18 is such that a ratio of the silver-selenide layer 18 to the chalcogenide glass layer 17 thicknesses is between about 5:1 and about 1:1. In other words, the thickness of the silver-selenide layer 18 is between about 1 to about 5 times greater than the thickness of the chalcogenide glass layer 17. Even more preferably, the ratio is between about 3.1:1 and about 2:1.

Referring now to FIG. 5, a silver layer 50 is plated on the silver-selenide layer 18 by an electroless process. The electroless plating process is less energetic than the conventionally used processes (e.g., sputtering and evaporation), which would cause an unknown amount of silver to be incorporated into the silver-selenide layer 18 during the energetic deposition process. Accordingly, by plating the silver layer 50 on the silver-selenide layer 18 using an electroless process, the amount of silver to be incorporated in the silver-selenide layer 18 can be better controlled.

In the illustrated embodiment, the silver layer 50 is plated to a thickness within the range of approximately 50 Å to approximately 250 Å, and preferably to approximately 200 Å. To plate the silver layer 50 onto the silver-selenide layer 18, the silver-selenide layer 18 is first activated using an appropriate activation chemistry. The activation chemistry allows the plating of the silver onto the silver-selenide layer 18.

According to one exemplary embodiment, the silver-selenide layer 18 can be activated by exposure to a nickel (Ni) and gold (Au) colloidal mixture (e.g., Ronamerse) for approximately 5 minutes. According to another exemplary embodiment, the silver-selenide layer 18 can be activated by exposure to colloidal palladium (Pd) particles for approximately 5 minutes. Alternatively, the silver-selenide layer 18 can be activated by exposure to a solution of 500 ml water; 0.5 g palladium chloride (PdCl₂), and 1 ml hydrogen fluoride (HF) for approximately 90 seconds. According to yet another exemplary embodiment, the silver-selenide layer 18 can be activated by first exposing the layer 18 to a solution of dimethylethylenediamine for approximately 2 minutes and then, exposing the layer 18 to a solution of 500 ml water, 0.5 g palladium chloride, and 1 ml hydrogen fluoride for approximately one minute.

If desired, prior to activation, the silver-selenide layer 18 can be pretreated to prepare the silver-selenide layer 18 for activation. Such a pretreatment can include a cleaning step. For example, the silver-selenide layer 18 can be exposed to a mixture of ammonium fluoride (NH₄F) and phosphoric acid (H₃PO₄). An exemplary mixture is available under the name Blend B from General Chemical.

Once the silver-selenide layer 18 is properly activated, it is exposed to a plating solution for a period of time. The amount of time the silver-selenide layer 18 is exposed to the plating solution can be adjusted to achieve the desired thickness of the plated silver layer 50. Preferably, the activated silver-selenide layer 18 is exposed to the plating solution for a period of time sufficient to deposit a silver layer 50 having a thickness within the range of approximately 50 Å to approximately 250 Å, and more preferably approximately 200 Å. According to exemplary embodiments of the invention, the electroless plating solution includes water, a water soluble compound containing silver (e.g., silver nitrate (AgNO₃), among others), a chelating agent (e.g., tartrate, Ethylenediaminetetraacetic Acid (EDTA), among others) that prevents chemical reduction of the metal ions in solution while permitting selective chemical reduction on a surface of the substrate, and a chemical reducing agent (e.g., imidazole, glucose, hydrazine, among others). Additionally, the plating solution may include a buffer for controlling pH and various optional additives, such as bath stabilizers and surfactants.

A first exemplary plating solution includes: 100 milliliters (ml) water (H₂O); 5 ml ammonium hydroxide (NH₄OH); 3 grams (g) ammonium sulfate ((NH₄)SO₄); 1.25 g silver nitrate (AgNO₃); and 2 g tartrate. Optionally, an additional reducing agent, such as ammonium hypophosphite ((NH₄)₃PO₂), can also be added. A second exemplary plating solution includes: 150 ml water; 0.81 g silver nitrate; 5.5 g ammonium hydroxide (NH₄OH); 4.3 5ml acetic acid (CH₃COOH); and approximately 0.2 to approximately 2 g EDTA. Optionally, an additional reducing agent, such as hydrazine can be added. Preferably approximately 70 microliters (μl) of hydrazine are added to the second exemplary plating solution. According to another embodiment of the invention, a third exemplary plating solution can include: 150 ml water; 0.8 g silver nitrate; 2.4 g succinimide; 1.8 g imidazole; and 1 ml ammonium hydroxide. Optionally, an additional reducing agent, such as hydrazine can be added.

When the plating solution according to the specific embodiment described above is used and layer 18 is activated according to a specific embodiment described above, the plating time is preferably within the range of approximately 10 minutes to approximately 15 minutes. Additionally, the plating solution is preferably at a temperature within the range of approximately 55° C. to approximately 60° C.

Once all of the components are combined in a suitable container, the water soluble silver salt dissolves, releasing silver ions into the solution. The complexing agent strongly binds with the silver ions, preventing them from being reduced in the solution, but permitting reduction of the silver on the activated silver-selenide layer 18 surface. Specifically, the activated silver-selenide layer 18 surface acts as a catalyst, allowing the reduction of silver ions to metallic silver, which is deposited on the surface of the activated silver-selenide layer 18.

Subsequently, silver from the silver layer 50 is diffuses into the silver-selenide layer 18. Diffusion of the silver from silver layer 50 causes an excess of silver in the silver-selenide layer 18, making the silver-selenide layer 18 silver-rich (Ag₂₊ₓSe).

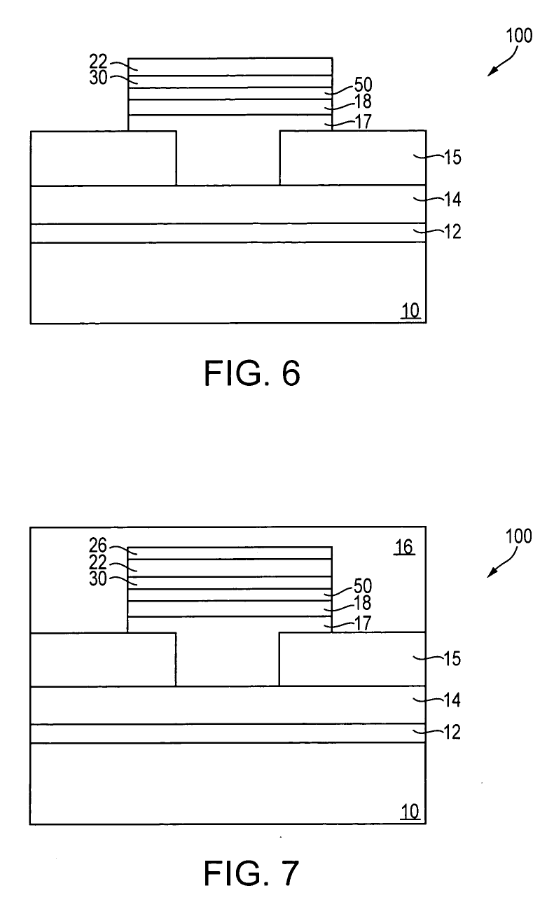

As shown in FIG. 6, an optional conductive adhesion layer 30 is formed over the silver layer 50 and a top electrode 22 is formed over the conductive adhesion layer 30. Suitable materials for the conductive adhesion layer include conductive materials capable of providing good adhesion between the silver layer 50 and the top electrode layer 22. Desirable materials for the conductive adhesion layer 30 include chalcogenide glasses.

The top and bottom electrodes 22, 14 can be any conductive material, such as tungsten, tantalum, aluminum, platinum, silver, and conductive nitrides. The bottom electrode 14 is preferably tungsten. The top electrode 22 is preferably tungsten or tantalum nitride.

The conductive adhesion layer 30 may be the same chalcogenide glass material used in the chalcogenide glass layer 17 discussed above. In this case, the conductive adhesion layer 30 can be formed by sputtering the chalcogenide glass onto the silver layer 50. A small amount of silver from the silver layer 50 is incorporated into the chalcogenide glass adhesion layer 30 when sputter deposited over the silver layer 50 due to the energetic nature of the sputtering process. Thus, the top electrode 22 shorts to the chalcogenide glass adhesion layer 30, creating a conductive path from the top electrode 22 to the first glass layer 17. The desired thickness of a chalcogenide glass conductive adhesion layer 30 is about 100 Å.

Use of a conductive adhesion layer 30 between the silver layer 50 and the top electrode 22 can prevent peeling of the top electrode 22 material during subsequent processing steps such as photoresist stripping. Electrode 22 materials, including tungsten, tantalum, tantalum-nitride, and titanium, among others, may not adhere well to silver layer 50. For example, adhesion between the two layers 50, 22 may be insufficient to prevent the electrode 22 layer from at least partially separating (peeling) away from the underlying silver layer 50 and thus losing electrical contact with the underlying layers 18, 17, 14 of the memory element 100. Poor contact between the top electrode 22 and the underlying memory element layers 18, 17, 14 can lead to electrical performance problems and unreliable switching characteristics. Use of a conductive adhesion layer 30 can substantially eliminate this problem.

Use of the silver-selenide layer 18 in contact with the chalcogenide glass layer 17 can eliminate the need to dope the chalcogenide glass layer 17 with a metal during formation of the memory element 100. The silver-selenide layer 18 provides a source of silver-selenide, which is driven into chalcogenide glass layer 17 by a conditioning step after formation of the memory element 100 (FIG. 11). Specifically, the conditioning step comprises applying a potential across the memory element structure 100 such that silver-selenide from the silver-selenide layer 18 is driven into the chalcogenide glass layer 17, forming a conducting channel. Movement of Ag⁺ ions into or out of that channel causes an overall resistance change for the memory element 100. The conditioning potential generally has a longer pulse width and higher amplitude than a potential used to program the memory element. After the conditioning step, the memory element 100 may be programmed.

Referring now to FIG. 7, an optional tungsten nitride layer 26 may be formed over the second electrode material 22. One or more additional dielectric layers 16 may be formed over the second electrode 22 or alternatively over the tungsten nitride layer 26 and the first dielectric layer 15 (as shown) to isolate the resistance variable memory element 100 from other structures fabricated over the substrate. Conventional processing steps can then be carried out to electrically couple the second electrode 22 to various circuits of memory arrays.

The embodiments described above refer to the formation of only a few possible resistance variable memory element 100 structures in accordance with the invention. It must be understood, however, that the invention contemplates the formation of other such resistance variable memory elements, which can be fabricated as a memory array and operated with memory element access circuits.

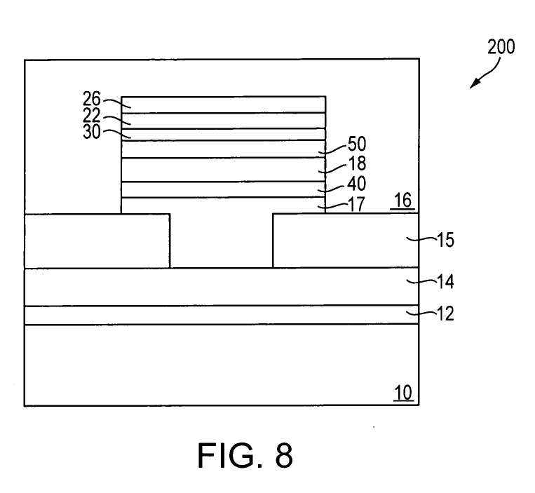

The memory element 100 show in FIG. 7 is exemplary only. Accordingly, a memory element 100 formed according to the invention can include additional layers. For example, as shown in FIG. 8, the memory element 100 can include a second silver layer 40 below the silver selenide layer 18. Preferably, the silver layer 40 has a thickness of approximately 50 Å. The silver layer 40 can be formed by any suitable method, such as sputtering and evaporation.

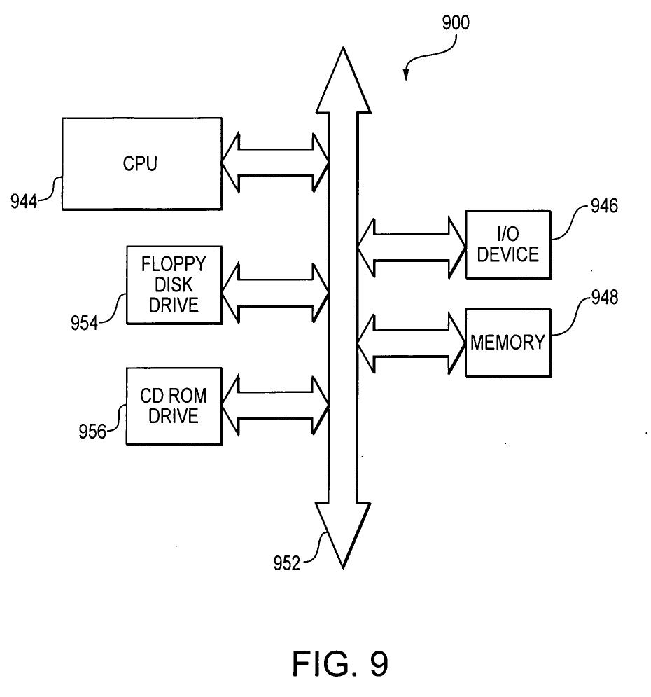

FIG. 9 illustrates a typical processor system 900 which includes a memory circuit 948, for example a programmable conductor RAM, which employs resistance variable memory elements fabricated in accordance with the invention. A processor system, such as a computer system, generally comprises a central processing unit (CPU) 944, such as a microprocessor, a digital signal processor, or other programmable digital logic devices, which communicates with an input/output (I/O) device 946 over a bus 952. The memory 948 communicates with the system over bus 952 typically through a memory controller.

In the case of a computer system, the processor system 900 may include peripheral devices such as a floppy disk drive 954 and a compact disc (CD) ROM drive 956, which also communicate with CPU 944 over the bus 952. Memory 948 is preferably constructed as an integrated circuit, which includes one or more resistance variable memory elements 100 (FIGS. 1-8). If desired, the memory 948 may be combined with the processor, for example CPU 944, in a single integrated circuit.

The above description and drawings are only to be considered illustrative of exemplary embodiments which achieve the features and advantages of the invention. Modification and substitutions to specific process conditions and structures can be made without departing from the spirit and scope of the invention. Accordingly, the invention is not to be considered as being limited by the foregoing description and drawings, but is only limited by the scope of the appended claims.

What is claimed as new and desired to be protected by Letters Patent of the United States is:

1. A method of forming a resistance variable memory element, the method comprising the steps of:
forming a first electrode;
forming a layer of resistance variable material over the first electrode;
forming a silver-selenide layer over the first layer of resistance variable material; and
plating a first silver layer on the silver-selenide layer by an electroless process.

2. The method of claim 1, wherein the plating act comprises plating the first silver layer having a thickness within the range of approximately 50 Åto approximately 250 Å.

3. The method of claim 2, wherein the plating act comprises plating the first silver layer having a thickness of approximately 200 Å.

4. The method of claim 1, further comprising the act of diffusing silver from the first silver layer into the silver-selenide layer to form a silver-rich silver selenide layer.

5. The method of claim 1, wherein the resistance variable material is germanium-selenide glass having a GeₓSe₁₀₀₋ₓ stoichiometry.

6. The method of claim 1, further comprising the act of forming a second electrode over the first silver layer.

7. The method of claim 5, further comprising forming a conductive adhesion layer between the first silver layer and the second electrode.

8. The method of claim 6, wherein the conductive adhesion layer and the resistance variable material layer are a same material.

9. The method of claim 1, further comprising the act of forming a second silver layer between the layer of resistance variable material and the first electrode.

10. The method of claim 1, further comprising the act of activating the silver-selenide layer prior to the step of plating.

11. The method of claim 10, wherein the plating act comprises exposing the silver-selenide layer to a plating solution.

12. The method of claim 11, wherein the exposing act comprises exposing the silver-selenide layer to a plating solution comprising water, a water soluble silver comprising compound, a chelating agent, and a reducing agent.

13. The method of claim 11, wherein the exposing act comprises exposing the silver-selenide layer to a plating solution comprising water, ammonium hydroxide; ammonium sulfate; silver nitrate; and tartrate.

14. The method of claim 13, wherein the plating solution further comprises ammonium hypophosphite.

15. The method of claim 13, wherein the exposing act comprises exposing the silver-selenide layer to a plating solution comprising 100 ml water; 5 ml ammonium hydroxide; 3 g ammonium sulfate; 1.25 g silver nitrate; and 2 g tartrate.

16. The method of claim 11, wherein the exposing act comprises exposing the silver-selenide layer to a plating solution comprising water; silver nitrate; ammonium hydroxide; acetic acid; and EDTA.

17. The method of claim 16, wherein the plating solution further comprises hydrazine.

18. The method of claim 11, wherein the exposing act comprises exposing the silver-selenide layer to a plating solution comprising water; silver nitrate; succinimide; imidazole; and ammonium hydroxide.

19. The method of claim 18, wherein the plating solution further comprises hydrazine.

20. The method of claim 10, further comprising the act of pretreating the silver-selenide layer prior to the act of activating, the pretreating act comprising exposing the silver-selenide layer to a mixture of ammonium fluoride and phosphoric acid.

21. The method of claim 10, wherein the activating act comprises exposing the silver-selenide to a nickel and gold colloidal mixture.

22. The method of claim 21, wherein the exposing act is conducted for approximately 5 minutes.

23. The method of claim 21, wherein the plating act comprises exposing the silver-selenide layer to a plating solution at a temperature of approximately 55° C. for approximately 12 minutes, the plating solution comprising 100 ml water; 5 ml ammonium hydroxide; 3 g ammonium sulfate; 1.25 g silver nitrate; and 2 g tartrate.

24. The method of claim 10, wherein the activating act comprises exposing the silver-selenide to colloidal palladium particles.

25. The method of claim 24, wherein the exposing act is conducted for approximately 5 minutes.

26. The method of claim 24, wherein the plating act comprises exposing the silver-selenide layer to a plating solution at a temperature of approximately 60° C. for approximately 10 minutes, the plating solution comprising 100 ml water; 5 ml ammonium hydroxide; 3 g ammonium sulfate; 1.25 g silver nitrate; and 2 g tartrate.

27. The method of claim 10, wherein the activating act comprises exposing the silver-selenide to a solution of water, palladium chloride and hydrogen fluoride

28. The method of claim 27, wherein the activating act comprises exposing the silver-selenide to a solution of 500 ml water, 0.5 g palladium chloride, and 1 ml hydrogen fluoride.

29. The method of claim 28, wherein the exposing act is conducted for approximately 90 seconds.

30. The method of claim 28, wherein the plating act comprises exposing the silver-selenide layer to a plating solution at a temperature of approximately 60° C. for approximately 10 minutes, the plating solution comprising 100 ml water; 5 ml ammonium hydroxide; 3 g ammonium sulfate; 1.25 g silver nitrate; and 2 g tartrate.

31. The method of claim 30, wherein the plating solution further comprises ammonium hypophosphite.

32. The method of claim 27, wherein the activating act further comprises the act of exposing the silver-selenide layer to dimethylethylenediamine.

33. The method of claim 32, wherein the act of exposing the silver-selenide layer to dimethylethylenediamine is conducted prior to the act of exposing the silver-selenide layer to the solution.

34. The method of claim 33, wherein the act of exposing the silver-selenide layer to dimethylethylenediamine is conducted for approximately 2 minutes and the act of exposing the silver selenide layer to the solution is conducted for approximately 1 minute.

35. The method of claim 34, wherein the plating act comprises exposing the silver-selenide layer to a plating solution at a temperature of approximately 60° C. for approximately 10 minutes, the plating solution comprising 100 ml water; 5 ml ammonium hydroxide; 3 g ammonium sulfate; 1.25 g silver nitrate; and 2 g tartrate.

36. A method of forming a memory element, the method comprising the steps of:
forming a first electrode;
forming germanium-selenide glass layer having a GeₓSe₁₀₀₋ₓ stoichiometry over the first electrode;
forming a first silver-selenide layer over the first layer of germanium-selenide;
activating the silver-selenide layer;
plating a silver layer on the silver-selenide layer by an electroless process subsequent to the activating act;
forming a second layer of germanium-selenide glass having a GeₓSe₁₀₀₋ₓ stoichiometry over the first silver layer;
forming a second electrode over the second germanium-selenide glass layer; and
forming an insulating layer over the second electrode.

37. A method of forming a silver-rich silver selenide layer, the method comprising the steps of:
forming a silver-selenide layer;
plating a silver layer on the silver-selenide layer by an electroless process; and
diffusing silver from the silver layer into the silver-selenide layer.

38. The method of claim 37, wherein the plating act comprises plating the silver layer having a thickness within the range of approximately 50 Å to approximately 250 Å.

39. The method of claim 38, wherein the plating act comprises plating the silver layer having a thickness of approximately 200 Å.

40. The method of claim 37, further comprising the act of diffusing silver from the silver layer into the silver-selenide layer to form a silver-rich silver selenide layer.

41. The method of claim 37, further comprising the act of activating the silver-selenide layer prior to the step of plating.

42. The method of claim 41, wherein the plating act comprises exposing the silver-selenide layer to a plating solution.

43. The method of claim 42, wherein the exposing act comprises exposing the silver-selenide layer to a plating solution comprising water, a water soluble silver comprising compound, a chelating agent, and a reducing agent.

44. The method of claim 42, wherein the exposing act comprises exposing the silver-selenide layer to a plating solution comprising water, ammonium hydroxide; ammonium sulfate; silver nitrate; and tartrate.

45. The method of claim 44, wherein the plating solution further comprises ammonium hypophosphite.

46. The method of claim 42, wherein the exposing act comprises exposing the silver-selenide layer to a plating solution comprising 100 ml water; 5 ml ammonium hydroxide; 3 g ammonium sulfate; 1.25 g silver nitrate; and 2 g tartrate.

47. The method of claim 42, wherein the exposing act comprises exposing the silver-selenide layer to a plating solution comprising water; silver nitrate; ammonium hydroxide; acetic acid; and EDTA.

48. The method of claim 42, wherein the exposing act comprises exposing the silver-selenide layer to a plating solution comprising 150 ml water; 0.81 g silver nitrate; 5.5 g ammonium hydroxide; 4.3 ml acetic acid; and approximately 0.2 to approximately 2 g EDTA.

49. The method of claim 48, wherein the plating solution further comprises hydrazine.

50. The method of claim 49, wherein the plating solution comprises approximately 70 μl of hydrazine.

51. The method of claim 42, wherein the exposing act comprises exposing the silver-selenide layer to a plating solution comprising water; silver nitrate; succinimide; imidazole; and ammonium hydroxide.

52. The method of claim 42, wherein the exposing act comprises exposing the silver-selenide layer to a plating solution comprising 150 ml water; 0.8 g silver nitrate; 2.4 g succinimide; 1.8 g imidazole; and 1 ml ammonium hydroxide.

53. The method of claim 52, wherein the plating solution further comprises hydrazine.

54. The method of claim 41, further comprising the act of pretreating the silver-selenide layer prior to the activating act, the pretreating act comprising exposing the silver-selenide layer to a mixture of ammonium fluoride and phosphoric acid.

55. The method of claim 42, wherein the activating act comprises exposing the silver-selenide to a nickel and gold colloidal mixture.

56. The method of claim 55, wherein the exposing act is conducted for approximately 5 minutes.

57. The method of claim 55, wherein the plating act comprises exposing the silver-selenide layer to a plating solution at a temperature of approximately 55° C. for approximately 12 minutes, the plating solution comprising 100 ml water; 5 ml ammonium hydroxide; 3 g ammonium sulfate; 1.25 g silver nitrate; and 2 g tartrate.

58. The method of claim 41, wherein the activating act comprises exposing the silver-selenide to colloidal palladium particles.

59. The method of claim 58, wherein the exposing act is conducted for approximately 5 minutes.

60. The method of claim 58, wherein the plating act comprises exposing the silver-selenide layer to a plating solution at a temperature of approximately 60° C. for approximately 10 minutes, the plating solution comprising 100 ml water; 5 ml ammonium hydroxide; 3 g ammonium sulfate; 1.25 g silver nitrate; and 2 g tartrate.

61. The method of claim 41, wherein the activating act comprises exposing the silver-selenide to a solution of water, palladium chloride and hydrogen fluoride

62. The method of claim 50, wherein the activating act comprises exposing the silver-selenide to a solution of 500 ml water, 0.5 g palladium chloride, and 1 ml hydrogen fluoride.

63. The method of claim 62, wherein the exposing act is conducted for approximately 90 seconds.

64. The method of claim 62, wherein the plating act comprises exposing the silver-selenide layer to a plating solution at a temperature of approximately 60° C. for approximately 10 minutes, the plating solution comprising 100 ml water; 5 ml ammonium hydroxide; 3 g ammonium sulfate; 1.25 g silver nitrate; and 2 g tartrate.

65. The method of claim 64, wherein the plating solution further comprises ammonium hypophosphite.

66. The method of claim 62, wherein the activating act further comprises the act of exposing the silver-selenide layer to dimethylethylenediamine.

67. The method of claim 66, wherein the act of exposing the silver-selenide layer to dimethylethylenediamine is conducted prior to the act of exposing the silver-selenide layer to the solution.

68. The method of claim 67, wherein the act of exposing the silver-selenide layer to dimethylethylenediamine is conducted for approximately 2 minutes and the act of exposing the silver selenide layer to the solution is conducted for approximately 1 minute.

69. The method of claim 68, wherein the plating act comprises exposing the silver-selenide layer to a plating solution at a temperature of approximately 60° C. for approximately 10 minutes, the plating solution comprising 100 ml water; 5 ml ammonium hydroxide; 3 g ammonium sulfate; 1.25 g silver nitrate; and 2 g tartrate.

70. A method of forming a silver-rich silver selenide layer, the method comprising the steps of:
forming a silver-selenide layer;
activating the silver-selenide layer;
plating a silver layer on the silver-selenide layer using an electroless process by exposing the silver-selenide layer to a plating solution comprising water, a water soluble silver comprising compound, a chelating agent, and a reducing agent; and
diffusing silver from the silver layer into the silver-selenide layer.

71. A method of forming a silver-rich silver selenide layer, the method comprising the steps of:
forming a silver-selenide layer;
activating the silver-selenide layer;
plating a silver layer on the silver-selenide layer using an electroless process by exposing the silver-selenide layer to a plating solution comprising water, ammonium hydroxide; ammonium sulfate; silver nitrate; and tartrate; and
diffusing silver from the silver layer into the silver-selenide layer.

72. The method of claim 71, wherein the activating act comprises exposing the silver-selenide to a nickel and gold colloidal mixture for approximately 5 minutes.

73. The method of claim 72, wherein the plating act comprises exposing the silver-selenide layer to the plating solution at a temperature of approximately 55° C. for approximately 12 minutes

74. The method of claim 71, wherein the activating act comprises exposing the silver-selenide to colloidal palladium particles for approximately 5 minutes.

75. The method of claim 74, wherein the plating act comprises exposing the silver-selenide layer to the plating solution at a temperature of approximately 60° C. for approximately 10 minutes

76. The method of claim 71, wherein the activating act comprises exposing the silver-selenide to a solution of 500 ml water, 0.5 g palladium chloride, and 1 ml hydrogen fluoride.

77. The method of claim 76, wherein the exposing act is conducted for approximately 90 seconds.

78. The method of claim 77, wherein the plating act comprises exposing the silver-selenide layer to the plating solution at a temperature of approximately 60° C. for approximately 10 minutes.

79. The method of claim 78, wherein the plating solution further comprises ammonium hypophosphite.

80. The method of claim 76, wherein the activating act further comprises the act of exposing the silver-selenide layer to dimethylethylenediamine prior to the act of exposing the silver-selenide layer to the solution.

81. The method of claim 80, wherein the act of exposing the silver-selenide layer to dimethylethylenediamine is conducted for approximately 2 minutes and the act of exposing the silver selenide layer to the solution is conducted for approximately 1 minute.

82. The method of claim 81, wherein the plating act comprises exposing the silver-selenide layer to the plating solution at a temperature of approximately 60° C. for approximately 10 minutes.
